(19) United States
(12) Patent Application Publication
(10) Pub. No.: US 2025/0196765 A1
(43) Pub. Date: Jun. 19, 2025

(54) VEHICLE HEADLAMP CONTROL DEVICE AND METHOD

(71) Applicant: HYUNDAI MOBIS CO., LTD., Seoul (KR)

(72) Inventors: Hyoung Jin CHOI, Yongin-si (KR); Jun Hyuk CHA, Yongin-si (KR); Chan Ho JOO, Yongin-si (KR)

(73) Assignee: HYUNDAI MOBIS CO., LTD., Seoul (KR)

(21) Appl. No.: 18/949,102

(22) Filed: Nov. 15, 2024

(30) Foreign Application Priority Data
Dec. 14, 2023 (KR) 10-2023-0181772

(51) Int. Cl. B60Q 1/50; B60Q 1/04; G08G 1/005

(52) U.S. Cl. CPC B60Q 1/547; B60Q 1/04; G08G 1/005; B60Q 2300/45

(57) ABSTRACT

A vehicle headlamp control device according to an embodiment of the present disclosure includes: a sensor; and a processor operatively connected to the sensor and transmitting a marking image of a three-dimensional pattern to a road surface through a headlamp of a vehicle, when a monitoring target is detected in front of the vehicle through the sensor.

### CROSS-REFERENCE TO RELATED APPLICATION

This application claims priority from and the benefit of Korean Patent Application No. 10-2023-0181772, filed on Dec. 14, 2023, which is hereby incorporated by reference for all purposes as if set forth herein.

### BACKGROUND

### Field

Exemplary embodiments of the present disclosure relate to vehicle headlamp control device and method.

### Discussion of the Background

Examples of road surface illumination lamps include DMDs and Micro LED lamps. The road surface illumination lamps, in particular, projection-type lamps, which have currently been employed in vehicles, may improve safety by projecting visual image information onto a road surface so that a pedestrian or driver may recognize the information.

However, the road surface illumination lamps convey information based only on the meaning of a projected graphic shape. Thus, if there is no prior knowledge of the image information, it may be difficult to properly understand the information. In addition, when communicating with pedestrians, there is a lack of content with psychological insights that may naturally guide safe pedestrian behavior.

In addition, an augmented reality navigation (AR Nav) device or a head-up display (HUD) is a device that displays driving information, required by a driver, in 3D on an image captured through a vehicle's window or front camera to increase intuitiveness compared to a conventional navigation system using a screen.

However, although the AR Nav device or the HUD is more intuitive than the display screen, it has limitations in that quick visual perspective switching is necessary to check traffic information, and expanding the device size and resolution is crucial to display detailed information.

The related art of the present disclosure is disclosed in Korean Patent Application Publication No. 10-2023-0060612 (published on May 8, 2023).

### SUMMARY

Various embodiments are directed to vehicle headlamp control device and method, which may improve traffic safety by guiding pedestrian behavior through lighting during driving at night.

Technical objectives of the present disclosure, are not limited to the technical objective(s) mentioned above, and other technical objective(s) not mentioned above will be clearly understood by those skilled in the art from the following description.

In an embodiment, a vehicle headlamp control device may include: a sensor; and a processor operatively connected to the sensor and transmitting a marking image of a three-dimensional pattern to a road surface through a headlamp of a vehicle, when a monitoring target is detected in front of the vehicle through the sensor.

In an embodiment, the vehicle headlamp control device may further include an input interface configured to enable selection of a driver's intention to yield to the monitoring target, when the monitoring target is detected in front of the vehicle through the sensor.

When the driver's intention to yield is selected through the input interface, the processor may transmit a marking image regarding driver yield content to the road surface.

In an embodiment, the vehicle headlamp control device may further include a memory storing a lookup table in which the marking image regarding the driver yield content is mapped and recorded, wherein the processor may use the lookup table stored in the memory to transmit the marking image regarding the driver yield content to the road surface.

The processor may measure a distance value between the vehicle and the monitoring object through the sensor and control the headlamp by considering the measured distance value.

The processor may measure a horizontal reference angle value between the vehicle and the monitoring object through the sensor and use the measured horizontal reference angle value to calculate an orientation angle value of the headlamp, and may control the headlamp by further considering the calculated orientation angle value.

The sensor may include at least one of a lidar, a radar, and a camera.

The marking image may be implemented as an animation of a three-dimensional projection lighting pattern from a driver's perspective to display a three-dimensional navigation direction, and may be implemented as an augmented reality (AR)-based image with a three-dimensional pattern or an AR-based animation with a sense of motion from a pedestrian's perspective to guide pedestrian avoidance.

In an embodiment, a vehicle headlamp control method may include: detecting, by a processor, a monitoring target in front of a vehicle through a sensor; and transmitting, by the processor, a marking image of a three-dimensional pattern to a road surface through a headlamp of the vehicle, when the monitoring target is detected.

In an embodiment, the vehicle headlamp control method may further include: providing, by the processor, an input interface configured to enable selection of a driver's intention to yield to the monitoring target, when the monitoring target is detected, wherein the transmitting of the marking image may include transmitting a marking image regarding driver yield content to the road surface, when the driver's intention to yield is selected through the input interface.

Specific details of other embodiments are included in the detailed description and the accompanying drawings.

According to an embodiment of the present disclosure, traffic safety may be improved by guiding pedestrian behavior through lighting during driving at night.

According to an embodiment of the present disclosure, traffic safety may be improved by enabling a pedestrian to communicate with the vehicle even without prior knowledge of information on road surface marking in a typical traffic environment and, in some cases, by guiding intuitive behavior (pedestrian interaction).

According to an embodiment of the present disclosure, driver's recognition rate of a pedestrian may be improved through lighting during driving at night, and safe driving information may be implemented as with augmented reality head-up display (AR-HUD) content without requiring the driver to switch visual perspectives (perspective and binocular parallax), thereby improving driver convenience and intuitiveness to enhance a sense of safety.

According to an embodiment of the present disclosure, no additional hardware (H/W) development is required to build a system; and devices already installed in the vehicle may be utilized, in particular, such as devices for detecting monitoring objects (a pedestrian, a rider, and the like) including a lidar, a radar, and a front detection camera and devices for transmitting communication content including a DMD and a micro-HD LED-equipped headlamp.

### BRIEF DESCRIPTION OF THE DRAWINGS

FIG. 1 is a block diagram illustrating a vehicle headlamp control device according to an embodiment of the present disclosure.

FIGS. 2 to 5 are exemplary views illustrating a marking image transmitted according to an embodiment of the present disclosure.

FIG. 6 is a flowchart illustrating a vehicle headlamp control method according to an embodiment of the present disclosure.

FIG. 7 is a flowchart illustrating the vehicle headlamp control method according to another embodiment of the present disclosure.

### DETAILED DESCRIPTION OF THE ILLUSTRATED

### Embodiments

Specific structural and functional descriptions of embodiments of the present disclosure disclosed herein have been illustrated merely for the purpose of describing embodiments of the present disclosure. Embodiments of the present disclosure may be implemented in various forms, and thus should not be construed as being limited to embodiments described herein.

The present disclosure is subject to various modifications and may have many forms, and thus certain embodiments will be illustrated by way of example in the accompanying drawings and described in detail herein. It should be understood, however, that this is not intended to limit the present disclosure to specific forms of embodiments, but the embodiments include all modifications, equivalents, and substitutes included in the spirit and scope of the present disclosure.

Terms such as first, second, and the like used herein may be used to describe various components, but the various components are not limited by these terms. The terms may be used for the purpose of distinguishing one component from another. For example, a first component may be referred to as a second component, and similarly, a second component may also be referred to as a first component, without departing from the scope of the present disclosure.

When a component is referred to as being “connected,” or “coupled” to another component, it may be directly connected or coupled to another component, but it should be understood that yet another component may be present between the component and another component. Conversely, when a component is referred to as being “directly connected” or “directly coupled” to another, it should be understood that still another component may not be present between the component and another component. Other expressions that describe relationships between components, such as “between” and “directly between” or “adjacent to”, “directly adjacent to”, and the like should be interpreted similarly.

The terminology used herein is only for the purpose of describing specific embodiments and is not intended to limit the scope of the present disclosure. Unless the context clearly dictates otherwise, the singular form includes the plural form. In the present disclosure, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

Unless otherwise defined, all terms used herein, including technical or scientific terms, shall have the same meaning as commonly understood by those skilled in the art. It will be further understood that terms, such as those defined in commonly used dictionaries, should be interpreted as having a meaning consistent with their meaning in the context of the relevant art, and shall not be construed to have an idealized or unduly formal meaning unless expressly so defined herein.

Hereinafter, embodiments of the present disclosure will be described in detail below with reference to the accompanying drawings. The same reference numerals are used for the same components in the drawings, and the same description of the same components will not be repeated.

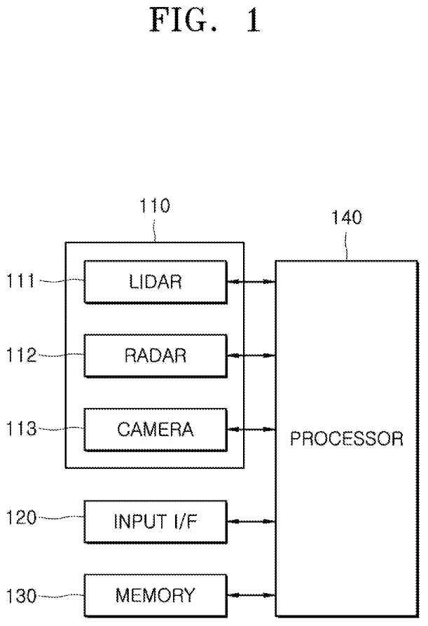

FIG. 1 is a block diagram illustrating a vehicle headlamp control device in according to an embodiment of the present disclosure.

Referring to FIG. 1, the vehicle headlamp control device 100 according to an embodiment of the present disclosure may be configured to include a sensor 110, an input interface (I/F) 120, a memory 130, and a processor 140.

The sensor 110 may include a lidar 111, a radar 112, and a camera 113. The sensor 110 may detect presence of a monitoring target, such as a pedestrian, rider, or the like, in front of a vehicle. To this end, the sensor 110 may be installed on a front portion of the vehicle.

The input interface 120 may be configured to enable selection of a driver's intention to yield to a monitoring target, when the monitoring target is detected in front of the vehicle through the sensor 110.

The input interface 120 may be configured to be displayed on a monitor screen provided in the vehicle, or, alternatively, may be configured to be displayed on a screen of a mobile terminal (e.g., a user's smartphone, smart pad, or the like.) paired with the vehicle through Bluetooth, or the like.

The memory 130 may store a lookup table in which a marking image regarding the driver yield content is mapped and recorded. The lookup table may be used by the processor 140 to transmit the driver yield content on a road surface.

When a monitoring target is detected in front of the vehicle through the sensor 110, the processor 140 may transmit a marking image of a three-dimensional pattern to a road surface through the headlamp of the vehicle.

Here, the marking image may be implemented as an animation of a three-dimensional projection lighting pattern from a driver's perspective to display a three-dimensional navigation direction.

In addition, the marking image may be implemented as an augmented reality (AR)-based image with a three-dimensional pattern or an AR-based animation with a sense of motion from a pedestrian's perspective to guide pedestrian avoidance.

When the driver's intention to yield is selected through the input interface 120, the processor 140 may transmit a marking image regarding driver yield content to the road surface.

To this end, the processor 140 may use the lookup table stored in the memory 130. That is, the processor 140 may extract the marking image regarding the driver yield content from the lookup table and transmit the extracted marking image to the road surface.

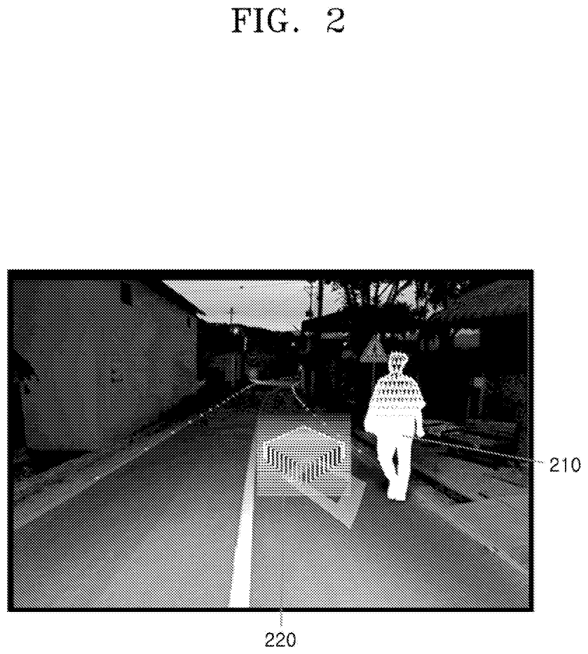

As illustrated in FIG. 2, the marking image transmitted to the road surface may be implemented as an animation of a three-dimensional projection lighting pattern from a driver's perspective (implementation of an AR feeling) to guide pedestrian avoidance through a three-dimensional navigation direction display function.

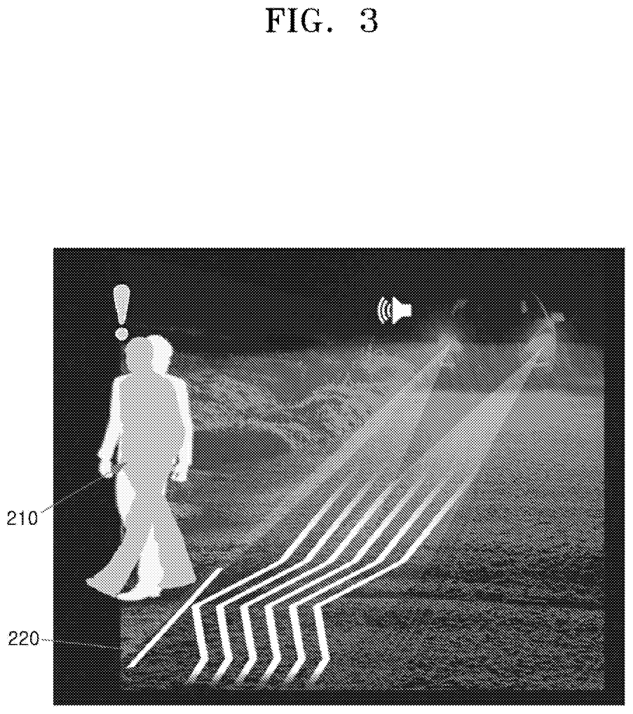

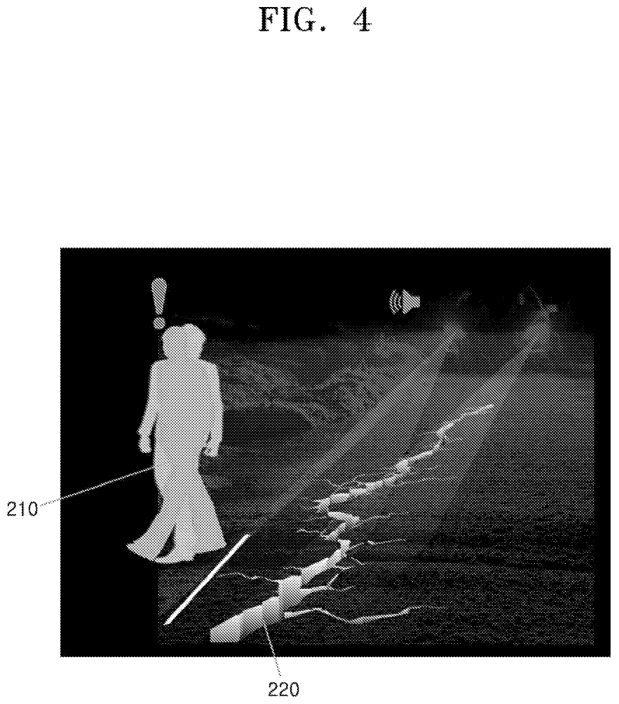

Alternatively, as illustrated in FIG. 3, the marking image transmitted to the road surface may be implemented as a three-dimensional pattern from a pedestrian's perspective to function as a safety guide with an AR feeling, thereby guiding pedestrian avoidance. Alternatively, as illustrated in FIG. 4, the marking image transmitted to the road surface may be implemented as a graphic with an AR feeling through a 3D image from a pedestrian's perspective to guide pedestrian behavior (avoidance).

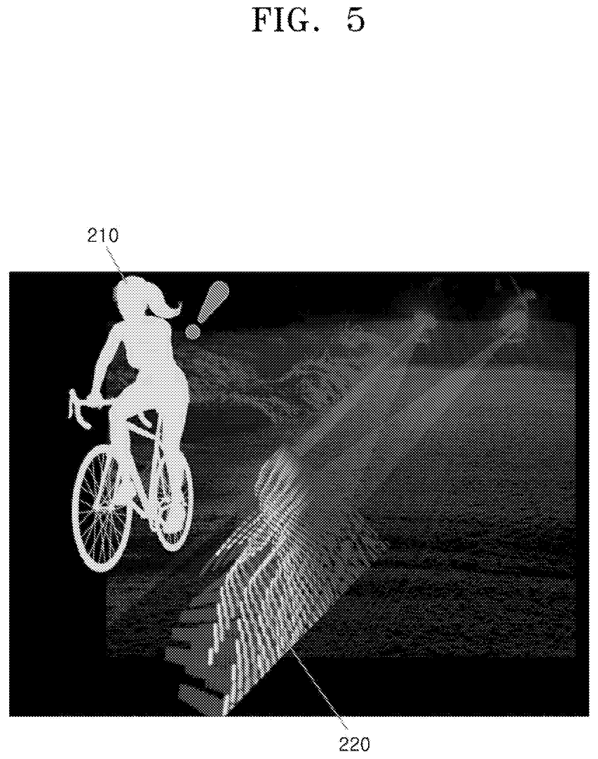

Alternatively, as illustrated in FIG. 5, the marking image transmitted to the road surface may be implemented as a graphic with an AR feeling of an animation with a sense of motion from a rider's perspective to guide pedestrian behavior (avoidance) and to also suggest a direction of vehicle travel.

In addition, the processor 140 may measure a distance value between the vehicle and the monitoring object through the sensor 110 and control the headlamp by considering the measured distance value.

Alternatively, the processor 140 may measure a horizontal reference angle value between the vehicle and the monitoring object through the sensor 110 and use the measured horizontal reference angle value to calculate an orientation angle value of the headlamp. The processor 140 may control the headlamp by considering the measured distance value along with the calculated orientation angle value.

That is, when controlling the headlamp, the processor 140 may use only a distance value between the vehicle and the monitoring object, or may use not only the distance value but also a horizontal reference angle value between the vehicle and the monitoring object.

In this way, the headlamp may transmit the marking image appropriately based on a position or angle of the monitoring target and display the marking image on the road surface, thereby efficiently guiding pedestrian avoidance and further improving traffic safety.

The devices described above may be implemented as a hardware component, a software components and/or a combination of hardware and software components. For example, the devices and components described in the embodiments may be implemented using one or more general-purpose computers or special-purpose computers, such as, for example, a processor, controller, arithmetic logic unit (ALU), digital signal processor, microcomputer, field programmable array (FPA), programmable logic unit (PLU), microprocessor, or any other device capable of executing and responding to an instruction. A processing device may execute an operating system (OS) and one or more software applications that are executed on the OS. In addition, the processing device may also access, store, manipulate, process, and generate data in response to the execution of software. For ease of understanding, a single processing device may be described as being used; however, those skilled in the art should understand that a processing device may include a plurality of processing elements and/or a plurality of types of processing elements. For example, a processing device may include a plurality of processors or one processor and one controller. In addition, other processing configurations, such as a parallel processor, are possible.

Software may include a computer program, code, instruction, or a combination of one or more thereof, and may configure a processing device to operate as desired or independently or collectively instruct a processing device. Software and/or data may be permanently or temporarily embodied in any type of machine, component, physical device, virtual equipment, computer storage medium or device, or in a transmitted signal wave, to be interpreted by the processing device or to provide an instruction or data to the processing device. Software may also be distributed over networked computer systems to be stored or executed in a distributed manner. The software and data may be stored on one or more computer-readable recording media.

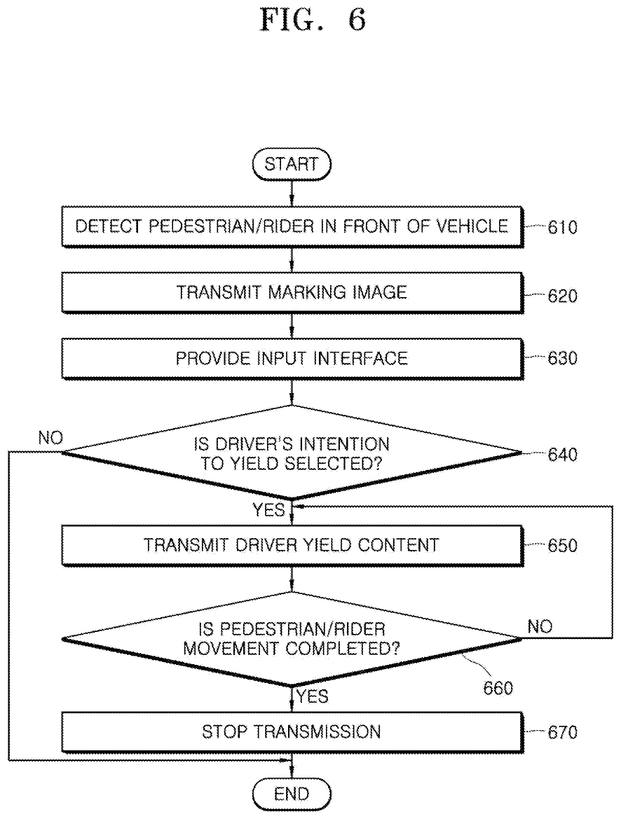

FIG. 6 is a flowchart illustrating a vehicle headlamp control method according to an embodiment of the present disclosure.

The vehicle headlamp control method described herein is only one embodiment of the present disclosure, and various other steps may be added when necessary, and the steps described below may be performed in a different order. Thus, the present disclosure is not limited to each of the steps and their order described below. This may also apply to other embodiments below.

Referring to FIGS. 1 and 6, a processor 140 of a vehicle headlamp control device 100 may detect, through a sensor 110, whether a monitoring object such as a pedestrian, rider, or the like is present in front of a vehicle in step 610.

Next, when the monitoring target is detected, the processor 140 of the vehicle headlamp control device 100 may transmit a marking image of a three-dimensional pattern to a road surface through a headlamp of the vehicle in step 620.

Next, the processor 140 of the vehicle headlamp control device 100 may provide an input interface 120 configured to enable selection of a driver's intention to yield to the monitoring target in step 630.

Next, when the driver's intention to yield is selected through the input interface 120 (a “yes” direction in step 640), the processor 140 of the vehicle headlamp control device 100 may transmit a marking image regarding driver yield content to the road surface in step 650.

Next, when the monitoring target (pedestrian/rider) completes movement (a “yes” direction in step 660), the processor 140 of the vehicle headlamp control device 100 may stop transmitting the marking image through driving control of the headlamp in step 670.

Meanwhile, the stopping of the transmission in step 670 may be performed even when a driver's intention to yield is not selected through the input interface 120 (a “no” direction in step 640).

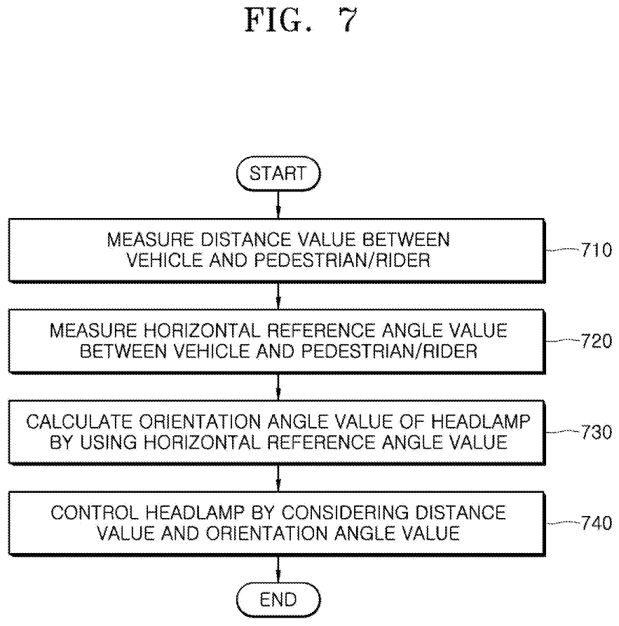

FIG. 7 is a flowchart illustrating the vehicle headlamp control method according to another embodiment of the present disclosure.

Referring to FIGS. 1 and 7, when a monitoring target (pedestrian/rider) is detected in front of a vehicle through the sensor 110, the processor 140 of the vehicle headlamp control device 100 may measure, through the sensor 110, a distance value between the vehicle and the pedestrian/rider in step 710.

Next, the processor 140 of the vehicle headlamp control device 100 may measure, through the sensor 110, a horizontal reference angle value between the vehicle and the pedestrian/rider in step 720.

Next, the processor 140 of the vehicle headlamp control device 100 may use the measured horizontal reference angle value to calculate an orientation angle value of the headlamp in step 730.

Next, the processor 140 of the vehicle headlamp control device 100 may control the headlamp by considering the measured distance value and the calculated orientation angle value in step 740.

Although the embodiments have been described above by limited embodiments and drawings, it will be apparent to those skilled in the art that various modifications and variations may be made from the above description. For example, suitable results may be achieved even if the described techniques are performed in a different order than the described method, and/or even if components of the described systems, structures, devices, circuits, and the like are combined or joined in a different form than the described method, or even if replaced or substituted by other components or equivalents.

Thus, other implementations, other embodiments, and equivalents of the claims are also within the scope of the following claims.

What is claimed is:

1. A vehicle headlamp control device comprising:
a sensor; and
a processor operatively connected to the sensor and transmitting a marking image of a three-dimensional pattern to a road surface through a headlamp of a vehicle, in response that a monitoring target is detected in front of the vehicle through the sensor.

2. The vehicle headlamp control device of claim 1, further including an input interface configured to enable selection of a driver's intention to yield to the monitoring target, in response that the monitoring target is detected in front of the vehicle through the sensor.

3. The vehicle headlamp control device of claim 2, wherein the processor transmits a marking image regarding driver yield content to the road surface, in response that the driver's intention to yield is selected through the input interface.

4. The vehicle headlamp control device of claim 3, further including:
a memory storing a lookup table in which the marking image regarding the driver yield content is mapped and recorded,
wherein the processor uses the lookup table stored in the memory to transmit the marking image regarding the driver yield content to the road surface.

5. The vehicle headlamp control device of claim 1, wherein the processor measures a distance value between the vehicle and the monitoring target through the sensor and controls the headlamp by considering the measured distance value.

6. The vehicle headlamp control device of claim 5, wherein the processor measures a horizontal reference angle value between the vehicle and the monitoring target through the sensor, uses the measured horizontal reference angle value to calculate an orientation angle value of the headlamp, and controls the headlamp by further considering the calculated orientation angle value.

7. The vehicle headlamp control device of claim 1, wherein the sensor includes at least one of a lidar, a radar, and a camera.

8. The vehicle headlamp control device of claim 1, wherein the marking image is implemented as an animation of a three-dimensional projection lighting pattern from a driver's perspective to display a three-dimensional navigation direction.

9. The vehicle headlamp control device of claim 1, wherein the marking image is implemented as an augmented reality (AR)-based image with a three-dimensional pattern or an AR-based animation with a sense of motion from a pedestrian's perspective to guide pedestrian avoidance.

10. A vehicle headlamp control method comprising:
detecting, by a processor, a monitoring target in front of a vehicle through a sensor operatively connected to the processor; and
transmitting, by the processor, a marking image of a three-dimensional pattern to a road surface through a headlamp of the vehicle, in response that the monitoring target is detected.

11. The vehicle headlamp control method of claim 10, further including:
providing, by the processor, an input interface configured to enable selection of a driver's intention to yield to the monitoring target, in response that the monitoring target is detected.

12. The vehicle headlamp control method of claim 11, wherein the transmitting of the marking image includes transmitting the marking image regarding driver yield content to the road surface, in response that the driver's intention to yield is selected through the input interface.

13. The vehicle headlamp control method of claim 12, further including:
using, by the processor, a lookup table stored in a memory operatively connected to the processor to transmit the marking image regarding the driver yield content to the road surface,
Wherein the lookup table includes the marking image regarding the driver yield content.

14. The vehicle headlamp control method of claim 10, further including:
measuring, by the processor, a distance value between the vehicle and the monitoring target through the sensor; and
controlling the headlamp by considering the measured distance value.

15. The vehicle headlamp control method of claim 14, further including:
measuring, by the processor, a horizontal reference angle value between the vehicle and the monitoring target through the sensor;
determining an orientation angle value of the headlamp by use of the measured horizontal reference angle value; and
controlling the headlamp by further considering the determined orientation angle value.

16. The vehicle headlamp control method of claim 10, wherein the marking image is implemented as an animation of a three-dimensional projection lighting pattern from a driver's perspective to display a three-dimensional navigation direction.

17. The vehicle headlamp control method of claim 10, wherein the marking image is implemented as an augmented reality (AR)-based image with a three-dimensional pattern or an AR-based animation with a sense of motion from a pedestrian's perspective to guide pedestrian avoidance.

18. A non-transitory computer readable storage medium on which a program for performing the method of claim 10 is recorded.
